(19) United States
(12) Patent Application Publication
(10) Pub. No.: US 2025/0026583 A1
(43) Pub. Date: Jan. 23, 2025

(54) APPARATUS AND METHOD FOR CONVEYING AND APPORTIONING

(71) Applicant: KRONES AG, Neutraubling (DE)

(72) Inventors: Niels CLAUSEN, Dollerup (DE); Jens LUECKE, Flensburg (DE); Konrad SENN, Alteglofsheim (DE); Christian DEPNER, Silberstedt (DE); Tobias BIERMEIER, Aholfing (DE); Christian HOLZER, Schierling (DE)

(21) Appl. No.: 18/715,454

(22) PCT Filed: Dec. 20, 2022
(86) PCT No.: PCT/EP2022/087058

§ 371 Date: May 31, 2024

(30) Foreign Application Priority Data
Dec. 21, 2021 (DE) 102021134078.0

(51) Int. Cl. B65G 47/52; B65B 35/24; B65B 55/00; B65G 43/08; B65G 47/64; B65G 47/71

(52) U.S. Cl. CPC B65G 47/525; B65B 35/24; B65B 55/00; B65G 43/08; B65G 47/644; B65G 47/71; B65G 2201/0235

(57) ABSTRACT

The invention relates inter alia to an apparatus for conveying and apportioning articles, preferably containers. The apparatus has a single-track conveyor region and a dual-track conveyor region, the latter being arranged directly downstream from the single-track conveyor region and having a first conveyor track and a second conveyor track. The apparatus has a distribution device which is configured to apportion articles, conveyed from the single-track conveyor region, to the first conveyor track and the second conveyor track. The dual-track conveyor region has a height-offset conveyor portion in which the first conveyor track is arranged higher than the second conveyor track. Advantageously, in the height-offset conveyor portion, articles still undistributed can be excited to move to the first conveyor track or the second conveyor track.

### TECHNICAL FIELD

The invention relates to an apparatus for conveying and apportioning articles, preferably containers. The invention further relates to a container handling system. The invention also relates to a method for conveying and apportioning articles, preferably containers.

### TECHNICAL BACKGROUND

Apparatuses for conveying and apportioning a single-track stream of articles into two single-track streams of articles in equal parts are known per se, for example from container handling systems for handling containers.

DE 297 23 800 U1 discloses an apparatus for apportioning a stream of articles transported between railings into a plurality of independent rows, which apportions the stream of articles conveyed on a plurality of oblique conveyor belts inclined in the direction of the railings into a plurality of independent rows of articles by means of an apportioning apparatus. The apportioning apparatus comprises a movable railing section that can be used to reversibly reduce the distance to the opposing railing section.

EP 0 121 106 A1 discloses an apparatus for distributing articles from an infeed conveyor to two or more outfeed conveyors as a function of certain characteristics of the articles, with a device for selectively transferring the articles transversely to the conveying direction. The articles are fed in such a manner that they come to rest on both outfeed conveyors at the latest at the transfer device and that the two outfeed conveyors are tilted towards one another in a roof-like manner for a certain distance at or below the transfer device.

A disadvantage of the known apparatuses can be their limited capacity, which can represent a bottleneck in production, especially in high-performance container handling systems. Known apparatuses often operate only up to a capacity of 60,000 containers per hour. In particular at higher capacities, the problem can arise due to the design that some of the containers cannot be distributed, since the conveying speed becomes very high and the speed of movement of the distributor element for apportioning the containers is limited.

The invention is based on the object of creating an improved technique for conveying and apportioning articles, preferably containers. Preferably, the technology is to enable a particularly high performance with the simultaneous safe apportioning of the articles.

### SUMMARY OF THE INVENTION

The object is achieved by the features of the independent claims. Advantageous developments are specified in the dependent claims and the description.

One aspect of the present disclosure relates to an apparatus for conveying and apportioning articles, preferably containers. The apparatus has a single-track conveyor region. The apparatus further has a dual-track conveyor region, which is arranged directly downstream of the single-track conveyor region (for example, centrally thereto) and has a first conveyor track and a second conveyor track. The apparatus also has a distribution device that is configured to apportion articles conveyed from the single-track conveyor region between the first conveyor track and the second conveyor track (for example, substantially evenly or 50:50). The dual-track conveyor region has a height-offset conveyor portion in which the first conveyor track is arranged higher than the second conveyor track.

Advantageously, in the height-offset conveyor portion, articles still undistributed (i.e., in particular articles that were not distributed to one of these tracks by the distribution device, for example upon switching over between the first conveyor track and the second conveyor track) can be excited to move to the first conveyor track or the second conveyor track. Typically, the undistributed articles run centrally on the dual-track conveyor region, i.e. partially on the first conveyor track and partially on the second conveyor track. The height offset allows the undistributed articles to be guided away from their center of gravity and subsequently choose one of the two conveyor tracks, so to speak. The height offset can, for example, cause a slight tilting of the undistributed article towards the second conveyor track, in such a manner that the undistributed article continues to the second conveyor track. On the other hand, the height offset can also cause a lifting off of the undistributed article from the second conveyor track, in such a manner that the divided article continues to the first conveyor track. This technology can advantageously enable the apparatus to be used in high-performance applications with significantly more than 60,000 articles, preferably containers, since undistributed articles can still be apportioned comparatively safely by the height offset. This technology is also easy and inexpensive to implement.

It is possible to detect an imbalance in the apportionment caused by the height-offset conveyor portion, for example by additionally counting the articles on the first conveyor track or the second conveyor track using a counting device. Based on the detection, a control unit of the apparatus can, for example, control the distribution device in such a manner that the apportionment is evened out.

Preferably, the first conveyor track and the second conveyor track can run directly next to one another in parallel and in a straight line.

For example, the first conveyor track can be configured as a conveyor belt track or a conveyor mat track. Alternatively or additionally, the second conveyor track can be configured as a conveyor belt track or a conveyor mat track.

Preferably, the height-offset conveyor portion can extend along a longitudinal axis or a conveying direction of the dual-track conveyor region, preferably over an entire width of the dual-track conveyor region.

Preferably, in the height-offset conveyor portion, the first conveyor track can be arranged >0 mm (or ≥1 mm) and/or ≤30 mm higher than the second conveyor track, preferably ≤10 mm or ≤3 mm higher, particularly preferably around 1 mm higher.

It should be noted that even a height adjustment of only 1 mm for precision machines such as the apparatus disclosed herein is still well above the manufacturing and assembly tolerances.

In one exemplary embodiment, an upper-side conveyor face of the first conveyor track is arranged higher in the height-offset conveyor portion than an upper-side conveyor face of the second conveyor track.

Preferably, in the height-offset conveyor portion, the upper-side conveyor face of the first conveyor track can be arranged >0 mm (or ≥1 mm) and/or ≤30 mm higher than the upper-side conveyor face of the second conveyor track, preferably ≤10 mm or ≤3 mm higher, particularly preferably around 1 mm higher.

In a further exemplary embodiment, the first conveyor track and the second conveyor track have upper longitudinal edges opposing one another. In the height-offset conveyor portion, the upper longitudinal edge of the first conveyor track is arranged higher than the upper longitudinal edge of the second conveyor track.

Preferably, in the height-offset conveyor portion, the upper longitudinal edge of the first conveyor track can be arranged >0 mm (or ≥1 mm) and/or ≤30 mm higher than the upper longitudinal edge of the second conveyor track, preferably ≤10 mm or ≤3 mm higher, particularly preferably around 1 mm higher.

In a further exemplary embodiment, the first conveyor track is inclined away from the second conveyor track, preferably in the height-offset conveyor portion. Alternatively or additionally, the second conveyor track is inclined away from the first conveyor track, preferably in the height-offset conveyor portion. Advantageously, an apportioning of articles to the first conveyor track and the second conveyor track can thus be supported.

In one embodiment, the first conveyor track and the second conveyor track are inclined in opposite directions relative to one another, preferably in a gable roof shape (for example, rising relative to one another). This can also be advantageous for apportioning the articles to the first conveyor track and the second conveyor track.

In a further embodiment, an angle of inclination of the first conveyor track and an angle of inclination of the second conveyor track are of different sizes, preferably in the height-offset conveyor portion. Alternatively or additionally, an angle of inclination of the first conveyor track is greater than an angle of inclination of the second conveyor track, preferably in the height-offset conveyor portion. Advantageously, an excitement of the articles still undistributed to move to the first conveyor track or the second conveyor track in a portion downstream of the distribution device can be further supported.

Preferably, the angle of inclination of the first conveyor track and/or the second conveyor track can be between 1° and 25°, preferably between 5° and 20°, particularly preferably between 10° and 15°.

Preferably, the angle of inclination of the first conveyor track can be at least 0.5° or at least 1° greater than the angle of inclination of the second conveyor track or vice versa.

Preferably, the angle of inclination of the first conveyor track and/or the angle of inclination of the second conveyor track can lie in a plane that is aligned perpendicular to a conveying direction of the dual-track conveyor region.

In a further embodiment, the dual-track conveyor region has a ramp conveyor sub-portion, which is preferably arranged at an upstream end of the height-offset conveyor portion. Preferably, the first conveyor track (and/or the upper-side conveyor face of the first conveyor track and/or the upper longitudinal edge of the first conveyor track) can rise in the ramp conveyor sub-portion compared to the second conveyor track (and/or the upper-side conveyor face of the second conveyor track and/or the upper longitudinal edge of the second conveyor track), for example by 1 mm to 5 mm.

In a further embodiment, the dual-track conveyor region has a slope conveyor sub-portion, which is preferably arranged at a downstream end of the height-offset conveyor portion. Preferably, the first conveyor track (and/or the upper-side conveyor face of the first conveyor track and/or the upper longitudinal edge of the first conveyor track) can drop in the slope conveyor sub-portion, preferably to a height of the second conveyor track (and/or the upper-side conveyor face of the second conveyor track and/or the upper longitudinal edge of the second conveyor track) or lower, for example by 1 mm to 5 mm.

It is also possible that the slope conveyor sub-portion is arranged at an upstream end of the height-offset conveyor portion and optionally the ramp conveyor sub-portion is arranged at a downstream end of the height-offset conveyor portion.

Optionally, the dual-track conveyor region can have a constant offset conveyor sub-portion, preferably arranged at a downstream end of the ramp conveyor sub-portion and/or at an upstream end of the slope conveyor sub-portion (or vice versa). Preferably, in the constant offset conveyor sub-portion, the first conveyor track (and/or the upper-side conveyor face of the first conveyor track and/or the upper longitudinal edge of the first conveyor track) can be arranged at a constant height level higher than the second conveyor track (and/or the upper-side conveyor face of the second conveyor track and/or the upper longitudinal edge of the second conveyor track), for example by 1 mm to 5 mm.

For example, the height-offset conveyor portion can have a total length of ≥1 m and/or ≤5 m or 7 m, preferably ≥2 m and/or ≤4 m, particularly preferably around 3 m, measured with respect to a longitudinal axis of the dual-track conveyor region.

In a further exemplary embodiment, longitudinal sides facing one another of the first conveyor track, preferably of a conveyor mat or a conveyor belt of the first conveyor track, and of the second conveyor track, preferably of a conveyor mat or a conveyor belt of the second conveyor track, taper towards one another or converge to a point relative to one another. Advantageously, a gap between the two conveyor tracks can be reduced, for example to less than 10 mm, less than 5 mm or less than 3 mm. This can advantageously prevent containers from being transported in a stable central position over the outer edges of the two conveyor tracks, which are spaced apart from one another, without the containers being subjected to movement towards one of the two conveyor tracks.

It is explicitly noted that the aspect with respect to the first conveyor track and the second conveyor track tapering towards one another or converging to a point is disclosed herein independently of the presence of the height-offset conveyor portion.

In one design variant, the distribution device is movable (for example, pivotable or displaceable) between a first position, in which the distribution device is positioned for distributing the articles to the first conveyor track, and a second position, in which the distribution device is positioned for distributing the articles to the second conveyor track.

In a further design variant, the distribution device is configured as a (for example, double or single) pivot flap or as a pivot channel.

In a further design variant, the distribution device is arranged at a downstream end of the single-track conveyor region (for example, in the middle).

In a further design variant, the apparatus further has a, preferably optical, detection device (for example, a light barrier), which is arranged to detect gaps between the articles conveyed from the single-track conveyor region, and a control unit, which is configured to control the distribution device as a function of a signal from the detection device, preferably to switch over the distribution device (for example, between the first position and the second position or between the first conveyor track of the second conveyor track) in a detected gap. This can advantageously ensure that the distribution device switches only in the gaps as much as possible, so that as few articles as possible are positioned undistributed partially on the first conveyor track and partially on the second conveyor track upon switching over.

In one exemplary embodiment, the apparatus further has an air supply device, preferably a compressed air nozzle or blower, for supplying the articles with an air flow for movement towards the first conveyor track or the second conveyor track. Preferably, the air supply device for supplying the articles with the air flow can be arranged in the height-offset conveyor portion or upstream of it. Advantageously, the air flow can excite articles still undistributed to move to the first conveyor track or second conveyor track.

In a further exemplary embodiment, the apparatus also has a (for example, displaceable or pivotable) overfeed device, preferably a slide or flap, which can be actuated to contact an article to overfeed it to the first conveyor track or the second conveyor track and is preferably arranged downstream of the distribution device. Advantageously, the overfeed device can be used to move articles still undistributed to the first conveyor track or second conveyor track.

In one embodiment, the apparatus further has a further conveyor region that has two diverging conveyor tracks, one of which is arranged downstream of the first conveyor track and the other of which is arranged downstream of the second conveyor track. Preferably, the two diverging conveyor tracks diverge to form a gap between them. Particularly preferably, one upstream end of the gap is unsecured, particularly preferably free of railings or free of a guard arranged to prevent articles from being conveyed into the gap. Advantageously, the undistributed articles at the end of the apparatus can be conveyed into the gap, in order to prevent the tipping over of undistributed articles or blocking caused by the undistributed articles.

In a further embodiment, the apparatus has a conveying capacity of ≥60,000 articles per hour or ≥80,000 articles per hour.

Preferably, the apparatus can have a conveying capacity of ≥100,000 articles per hour, ≥120,000 articles per hour or ≥150,000 articles per hour.

In a further design variant, the apparatus further has a first multi-track conveyor region that is arranged downstream of the first conveyor track (for example, downstream, preferably directly downstream, of one of the two diverging conveyor tracks of the further conveyor region). The apparatus further has a second multi-track conveyor region that is arranged downstream of the second conveyor track (for example, downstream, preferably directly downstream, of the other of the two diverging conveyor tracks of the further conveyor region). The apparatus further has a first apportioning device that is configured to apportion articles conveyed downstream of the first conveyor track to the first multi-track conveyor region (for example, evenly), and a second apportioning device that is configured to apportion articles conveyed downstream of the second conveyor track to the second multi-track conveyor region (for example, evenly). Preferably, the first apportioning device and/or the second apportioning device can be configured as a pivot flap or a pivot channel. In this manner, together with the adjusting device, a rapid single-track container stream can be apportioned into many (for example, four, six or eight) single-track container streams with relatively little effort, installation space and cost. Advantageously, even in the high-performance range (≥100,000 containers per hour), the apparatus can still reliably apportion into many single-track container streams.

It should be noted that the optional extension of the apparatus with the first multi-track conveyor region, the second multi-track conveyor region, the first apportioning device and the second apportioning device is disclosed herein independently of the presence and/or configuration of the height-offset conveyor portion. Accordingly, a further aspect of the present disclosure relates to an apparatus for conveying and apportioning articles, preferably containers. The apparatus has a single-track conveyor region. The apparatus has a dual-track conveyor region, which is arranged directly downstream of the single-track conveyor region and has a first conveyor track and a second conveyor track. The apparatus has a distribution device that is configured to apportion articles conveyed from the single-track conveyor region to the first conveyor track and the second conveyor track (for example, substantially evenly or 50:50). The apparatus further has a first multi-track conveyor region that is arranged downstream of the first conveyor track (for example, downstream, preferably directly downstream, of one of the two diverging conveyor tracks of the further conveyor region). The apparatus further has a second multi-track conveyor region that is arranged downstream of the second conveyor track (for example, downstream, preferably directly downstream, of the other of the two diverging conveyor tracks of the further conveyor region). The apparatus further has a first apportioning device that is configured to apportion articles conveyed downstream of the first conveyor track to the first multi-track conveyor region (for example, evenly), and a second apportioning device that is configured to apportion articles conveyed downstream of the second conveyor track to the second multi-track conveyor region (for example, evenly). Preferably, the first apportioning device and/or the second apportioning device can be configured as a pivot flap or a pivot channel.

Preferably, the first apportioning device can be arranged at a transition between one of the two diverging conveyor tracks and the first multi-track conveyor region. Alternatively or additionally, the second apportioning device can, for example, be arranged at a transition between the other of the two diverging conveyor tracks and the second multi-track conveyor region.

In a further design variant, the first apportioning device is controlled (for example, by means of a control unit) such that it switches in gaps between successive rows of articles conveyed downstream of the first conveyor track for switching between tracks of the first multi-track conveyor region, wherein the gaps preferably are detected by a sensor system of the apparatus and controlled, for example, as a function thereof (for example, by means of a control unit). Alternatively or additionally, the second apportioning device can, for example, be controlled (for example, by means of a control unit) such that it switches in gaps between successive rows of articles conveyed downstream of the second conveyor track for switching between tracks of the second multi-track conveyor region, wherein the gaps preferably are detected by a sensor system of the apparatus and controlled, for example, as a function thereof (for example, by means of a control unit). Advantageously, this enables a particularly safe and reliable switching over between the respective tracks so that, for example, no articles get stuck or tip over in the respective apportioning device.

It is possible that the sensor system is also part of the counting device. Advantageously, based on the detection of the sensor system, the distribution device can be controlled in such a manner that the apportioning is evened out by means of the distribution device, and the first and second distribution devices can be controlled in such a manner that they switch reliably in the gaps.

In a further design variant, the first multi-track conveyor region and/or the second multi-track conveyor region is controlled (for example, by means of a control unit) for decelerating the respective conveyed articles. In this manner, the articles can be advantageously recombined into a closed stream of articles, buffered and/or brought to a conveying speed for handling in a downstream handling apparatus.

A further aspect of the present disclosure relates to a container handling system for handling containers, having an apparatus as disclosed herein. Preferably, the container handling system can further have a pasteurizing apparatus for pasteurizing the containers, wherein the pasteurizing apparatus has a first container inlet, which is arranged downstream of the first conveyor track, and a second container inlet, which is arranged downstream of the second conveyor track. Alternatively, the container handling system can, for example, have a first inspection apparatus for inspecting the containers, which is arranged downstream of the first conveyor track, and a second inspection apparatus for inspecting the containers, which is arranged downstream of the second conveyor track. Alternatively, the container handling system can, for example, have a first packaging apparatus for packaging the containers, which is arranged downstream of the first conveyor track, and a second packaging apparatus for packaging the containers, which is arranged downstream of the second conveyor track. Alternatively, the container handling system can, for example, have a first container handling machine for handling the containers, which is arranged downstream of the first conveyor track, and a second container handling machine for handling the containers, which is arranged downstream of the second conveyor track.

Preferably, the container handling system can be configured for manufacturing, cleaning, coating, inspecting, filling, sealing, labeling, printing and/or packaging containers for liquid media, preferably beverages or liquid foodstuffs.

For example, the containers can be configured as bottles, cans, canisters, cartons, vials, etc.

Preferably, the term “control unit” can refer to an electronic system (for example, configured as a driver circuit or with microprocessor(s) and data memory) and/or a mechanical, pneumatic and/or hydraulic control system that, depending on the design, can perform control tasks and/or regulation tasks and/or processing tasks. Although the term “control” is used herein, this can also comprise or be understood as “regulate” or “feedback-control” and/or “process.”

A further aspect of the present disclosure relates to a method for conveying and apportioning articles, preferably containers, preferably by means of an apparatus as disclosed herein. The method comprises an (for example, even) apportioning of a stream of articles from a single-track conveyor region to a first conveyor track and a second conveyor track of a dual-track conveyor region by means of a distribution device, wherein, upon a switching over of the distribution device (for example between the first conveyor track and the second conveyor track), at least one article of the stream of articles is positioned undistributed partially on the first conveyor track and partially on the second conveyor track. The method further comprises exciting the at least one undistributed article to move to one of the first conveyor track and the second conveyor track by means of a height-offset conveyor portion of the dual-track conveyor region, in which the first conveyor track is arranged higher than the second conveyor track. Advantageously, the method can achieve the same advantages as already described with reference to the apparatus.

In one exemplary embodiment, the method further comprises blowing the at least one undistributed article by means of an air supply device for moving it to one of the first conveyor track and the second conveyor track.

In a further exemplary embodiment, the method further comprises overfeeding the at least one undistributed article to the first conveyor track or the second conveyor track by means of actuating an overfeed device.

In a further exemplary embodiment, the method further comprises supporting the excitation by an inclination of the first conveyor track and/or the second conveyor track, preferably by a different inclination of the first conveyor track and the second conveyor track.

In one embodiment, the method further comprises apportioning a first partial stream of articles downstream of the first conveyor track into tracks of a first multi-track conveyor region by means of a first apportioning device. The method can further comprise apportioning a second partial stream of articles downstream of the second conveyor track into tracks of a second multi-track conveyor region by means of a second apportioning device.

It should be noted that the optional extension of the method with the apportioning of the first partial stream of articles and the apportioning of the second partial stream of articles is disclosed herein independently of the excitation of the at least one undistributed article. Accordingly, a further aspect of the present disclosure relates to a method for conveying and apportioning articles, preferably containers, preferably by means of an apparatus as disclosed herein. The method comprises an (for example, even) apportioning of a stream of articles from a single-track conveyor region to a first conveyor track and a second conveyor track of a dual-track conveyor region by means of a distribution device. The method further comprises an apportioning of a first partial stream of articles downstream of the first conveyor track into tracks of a first multi-track conveyor region by means of a first apportioning device. The method can further comprise apportioning a second partial stream of articles downstream of the second conveyor track into tracks of a second multi-track conveyor region by means of a second apportioning device.

Preferably, the first partial stream of articles and the second partial stream of articles can originate from the stream of articles apportioned by the distribution device.

In a further embodiment, the method further comprises that, upon apportioning the first partial stream of articles, the first apportioning device switches in gaps (for example, detected by a sensor system) between successive rows of the first partial stream of articles for switching between the tracks of the first multi-track conveyor region, wherein the gaps are caused by the apportioning of the stream of articles by means of the distribution device.

In a further embodiment, the method further comprises that, upon apportioning the second partial stream of articles, the second apportioning device switches in gaps (for example, detected by means of a sensor system) between successive rows of the second partial stream of articles for switching between tracks of the second multi-track conveyor region, wherein the gaps are caused by the apportioning of the stream of articles by means of the distribution device.

In a further embodiment, the method further comprises a decelerating of articles from the first partial stream of articles by means of the first multi-track conveyor region and/or a decelerating of articles from the second partial stream of articles by means of the second multi-track conveyor region.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a top view of an apparatus for conveying and apportioning articles according to an exemplary embodiment of the present disclosure;

FIG. 2 shows a perspective view of the exemplary apparatus of FIG. 1 with articles;

FIG. 3 shows a sectional view through the exemplary apparatus of FIG. 1 in a height-offset conveyor portion;

FIG. 4 shows a purely schematic block diagram of a container handling system according to an exemplary embodiment of the present disclosure;

FIG. 5 shows a sectional view through a modified apparatus for conveying and apportioning articles according to an exemplary embodiment of the present disclosure;

FIG. 6 shows a top view of a portion of the modified apparatus of FIG. 5;

FIG. 7 shows a top view of a downstream end of an apparatus for conveying and apportioning articles according to an exemplary embodiment of the present disclosure;

FIG. 8 shows a sectional view through a height-offset conveyor portion of a modified apparatus for conveying and apportioning articles according to an exemplary embodiment of the present disclosure;

FIG. 9 shows a perspective view of a portion of an apparatus for conveying and apportioning articles according to an exemplary embodiment of the present disclosure; and

FIG. 10 shows a perspective view of a portion of an apparatus for conveying and apportioning articles according to an exemplary embodiment of the present disclosure.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

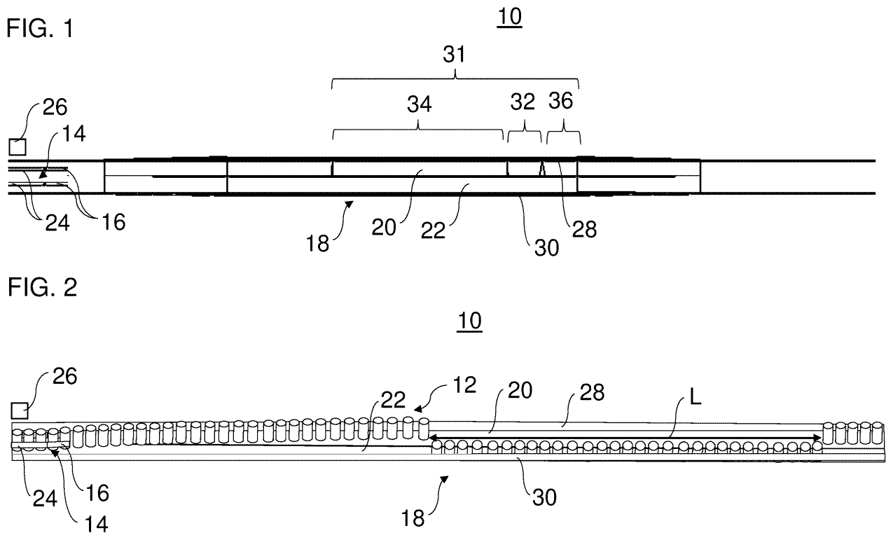

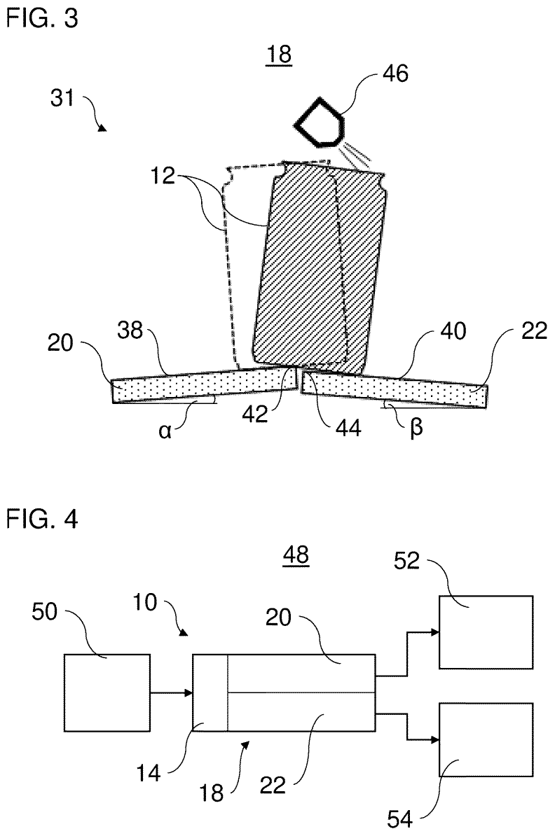

FIGS. 1 to 3 show different views of an apparatus 10 for conveying and apportioning articles 12 (only shown in FIGS. 2 and 3). The articles 12 are preferably configured as containers. Preferably, the apparatus 10 can be included in a container handling system for handling the articles 12 configured as containers. The apparatus 10 can transport the articles 12, which are configured as containers, through the container handling system and, for example, connect a plurality of container handling machines or container handling apparatuses to one another.

The apparatus 10 has a single-track conveyor region 14, a distribution device 16 and a dual-track conveyor region 18 with a first conveyor track 20 and a second conveyor track 22.

The single-track conveyor region 14 can convey a single-track stream of articles from the articles 12, preferably a single-track stream of containers. The articles 12 of the single-track stream of articles can be positioned one behind the other in a row. The single-track conveyor region 14 can preferably extend substantially linearly.

The single-track conveyor region 14 can, for example, be configured as a belt or mat conveyor region, preferably a mat chain conveyor region.

The single-track conveyor region 14 can have at least one guide 24 for guiding the articles 12 during conveying. Preferably, the single-track conveyor region 14 has two guides 24 opposing one another, which delimit the only conveyor track of the single-track conveyor region 14 between them. The at least one guide 24 can, for example, be configured as a guide railing or a guide wall. It is possible that the at least one guide 24 is adjustable, preferably transversely to a conveying direction of the single-track conveyor region 14. The at least one guide 24 can extend parallel to a longitudinal axis or conveying direction of the single-track conveyor region 14.

The distribution device 16 is configured to apportion the articles 12 conveyed from the single-track conveyor region 14 to the first conveyor track 20 and the second conveyor track 22. The distribution device 16 can be movable, preferably displaceable or pivotable, between a first position and a second position. In the first position, the distribution device 16 can be positioned in such a manner that it guides or distributes the articles 12 from the single-track conveyor region 14 to the first conveyor track 20. In the second position, the distribution device 16 can be positioned in such a manner that it directs or distributes the articles 12 from the single-track conveyor region 14 to the second conveyor track 22.

Preferably, the distribution device 16 can be configured as a single or double pivot flap or a pivot channel. In the first position, the distribution device 16 can be pivoted towards the first conveyor track 20, for example with a deflection angle in a range of ≤10°, ≤5° or ≤2.5° with respect to a conveying direction or longitudinal axis of the single-track conveyor region 14. In the second position, the distribution device 16 can be pivoted towards the second conveyor track 22, for example with a deflection angle in a range of ≤10°, ≤5° or ≤2.5° with respect to a conveying direction or longitudinal axis of the single-track conveyor region 14. In the illustrated exemplary embodiment of FIGS. 1 and 2, the distribution device 16 is configured as a double pivot flap or a pivot channel, which can guide the articles 12 between them.

The distribution device 16 can have at least one actuator for moving between the first position and the second position. The at least one actuator can be an electromagnetic, electromotive, pneumatic or hydraulic actuator, for example.

Preferably, the distribution device 16 can be arranged at a downstream end of the single-track conveyor region 14. For example, the distribution device 16 can be connected to a downstream end of the at least one guide 24. For example, the pivot flap or the pivot channel can extend the guide 24 in a conveying direction of the single-track conveyor region 14.

Optionally, the apparatus 10 can have a, preferably optical, detection device 26. The detection device 26 can be configured to detect gaps between the articles 12 on the first conveyor region 14. For example, the detection device 26 can be configured as a light barrier whose beam (for example, light, laser or LED beam) preferably runs perpendicular to a conveying direction of the first conveyor region 14. Based on a detection of the gaps by the detection device 26, a control unit (not shown) of the apparatus 10 can control the distribution device 16. Preferably, the distribution device 16 (or its actuator(s)) can be controlled by the control unit such that the distribution device 16 switches over between the first position and the second position in a gap detected by the detection device 26.

The dual-track conveyor region 18 is arranged directly downstream of the single-track conveyor region 14. Preferably, the dual-track conveyor region 18 is arranged relative to the single-track conveyor region 14 in such a way that the single-track conveyor region 14 meets an upstream end of the dual-track conveyor region 18 in the middle. In other words, preferably, the dual-track conveyor region 18 is arranged relative to the single-track conveyor region 14 such that it partially meets both the first conveyor track 20 and partially meets the second conveyor track 22. Preferably, a longitudinal axis or a conveying direction of the dual-track conveyor region 18 can be collinear or parallel with a longitudinal axis or a conveying direction of the single-track conveyor region 14.

The dual-track conveyor region 18 can convey a first single-track stream of articles on the first conveyor track 20 and a second single-track stream of articles on the second conveyor track 22. The articles of the single-track stream of articles can be positioned one behind the other in a row. The dual-track conveyor region 18 can preferably extend substantially linearly. The first conveyor track 20 and the second conveyor track 22 can preferably run directly next to one another in parallel and in a straight line.

The dual-track conveyor region 18 can, for example, be configured as a belt or mat conveyor region, preferably a mat chain conveyor region.

The dual-track conveyor region 18 can have at least one guide 28, 30 for guiding the articles 12 during conveying. Preferably, the dual-track conveyor region 18 has two guides 28, 30 opposing one another. The first guide 28 can delimit a longitudinal outer side of the first conveyor track 20. The second guide 30 can delimit a longitudinal outer side of the second conveyor track 22. There is no need for a guide, partition or the like between the conveyor tracks 20, 22. The at least one guide 28, 30 can, for example, be configured as a guide railing or a guide wall. It is possible that the at least one guide 28, 30 is adjustable, preferably transversely to a conveying direction of the dual-track conveyor region 18. The at least one guide 28, 30 can extend parallel to a longitudinal axis or conveying direction of the dual-track conveyor region 18. Preferably, the guides 28, 30 are aligned perpendicular to the conveyor tracks 20, 22.

The dual-track conveyor region 18 has a height-offset conveyor portion 31. Optionally, the height-offset conveyor portion 31 can have a ramp conveyor sub-portion 34, a constant offset conveyor sub-portion 32 and/or a slope conveyor sub-portion 36. The optional constant offset conveyor sub-portion 32 can be arranged between the ramp conveyor sub-portion 34 and the slope conveyor sub-portion 36.

In the height-offset conveyor portion 31, the first conveyor track 20 is arranged higher than the second conveyor track 22. Preferably, an upper-side conveyor face 38 of the first conveyor track 20 in the height-offset conveyor portion 31 is arranged higher than an upper-side conveyor face 40 of the second conveyor track 22 (see FIG. 3). Particularly preferably, in the height-offset conveyor portion 31, upper (inner) longitudinal edges 42, 44 opposing one another of the first conveyor track 20 and the second conveyor track 22 are arranged such that the upper longitudinal edge 42 of the first conveyor track 20 is arranged higher than the upper longitudinal edge 44 of the second conveyor track 22 (see also FIG. 3).

The height-offset conveyor portion 31 can extend along a longitudinal axis of the dual-track conveyor region 18.

The optional ramp conveyor sub-portion 34 can be arranged at an upstream end of the height-offset conveyor portion 31. In the ramp conveyor sub-portion 34, the first conveyor track 20/the upper-side conveyor face 38/the upper longitudinal edge 42 can rise relative to the second conveyor track 22/the upper-side conveyor face 40/the upper longitudinal edge 44. In the ramp conveyor sub-portion 34, the first conveyor track 20 can rise from a height level of the single-track conveyor region 14 to a height level of the first conveyor track 20 in the constant offset conveyor sub-portion 32. In the ramp conveyor sub-portion 34, a height level of the second conveyor track 22 can be substantially constant. Preferably, the ramp conveyor sub-portion 34 can be longer than the constant offset conveyor sub-portion 32, measured with respect to the longitudinal axis of the dual-track conveyor region 18.

The optional constant offset conveyor sub-portion 32 can connect the ramp conveyor sub-portion 34 and the slope conveyor sub-portion 36 to one another. In the constant offset conveyor sub-portion 32, the first conveyor track 20 can be arranged at a constant height level higher than the second conveyor track 22. Preferably, in the constant offset conveyor sub-portion 32, an upper-side conveyor face 38 of the first conveyor track 20 is arranged at a constant height level higher than an upper-side conveyor face 40 of the second conveyor track 22 (see FIG. 3). Particularly preferably, in the constant offset conveyor sub-portion 32, upper (inner) longitudinal edges 42, 44 opposing one another of the first conveyor track 20 and the second conveyor track 22 are arranged such that the upper longitudinal edge 42 of the first conveyor track 20 is arranged at a constant height level higher than the upper longitudinal edge 44 of the second conveyor track 22 (see also FIG. 3). In a further embodiment, in the constant offset conveyor sub-portion 32, the upper (inner) longitudinal edges 42, 44 opposing one another of the first conveyor track 20 and the second conveyor track 22 can be arranged such that the upper longitudinal edge 42 of the first conveyor track 20 is arranged at a constant height level that corresponds to the height level of the upper longitudinal edge 44 of the second conveyor track 22.

The optional slope conveyor sub-portion 36 can be arranged at a downstream end of the height-offset conveyor portion 31. In the slope conveyor sub-portion 36, the first conveyor track 20/the upper-side conveyor face 38/the upper longitudinal edge 42 can drop to a height or a height level of the second conveyor track 22/the upper-side conveyor face 40/the upper longitudinal edge 44. In the slope conveyor sub-portion 36, a height level of the second conveyor track 22 can be substantially constant. Preferably, the slope conveyor sub-portion 36 can be shorter than the ramp conveyor sub-portion 34, measured with respect to the longitudinal axis of the dual-track conveyor region 18. The slope conveyor sub-portion 36 can be adjacent to the ramp conveyor sub-portion 34 or to the constant offset conveyor sub-portion 32. It is also possible that the arrangement of the slope conveyor sub-portion 36 and the ramp conveyor sub-portion 34 is reversed.

It is possible that the first conveyor track 20 and/or the second conveyor track 22 is arranged in a manner inclined or set at an angle, for example with an angle of inclination a or B of between 1° and 25°, preferably between 5° and 20°, particularly preferably between 10° and 15°. Preferably, the first conveyor track 20 and/or the second conveyor track 22 is arranged in a manner inclined in the height-offset conveyor portion 31, particularly preferably in the ramp conveyor sub-portion 34, the constant offset conveyor sub-portion 32 and/or the slope conveyor sub-portion 36.

Specifically, the first conveyor track 20 can be inclined away from the second conveyor track 22. It is also possible that the second conveyor track 22 is inclined away from the first conveyor track 20. Preferably, the first conveyor track 20 and the second conveyor track 22 are inclined in opposite directions relative to one another, preferably in a gable roof shape. It is possible that an angle of inclination a of the first conveyor track 20 differs from an angle of inclination B of the second conveyor track 22.

The angles of inclination a and B can lie in a sectional plane that is aligned perpendicular to a conveying direction of the dual-track conveyor region 18. The angles of inclination a and B can be measured between an alignment plane of the respective conveyor track 20 or 22 and a horizontal plane.

The apparatus 10 can be operated in such a manner that a stream of articles from the single-track conveyor region 14 is apportioned between the first conveyor track 20 and the second conveyor track 22 by means of the distribution device 16. For example, a row of a plurality of articles 12 can be guided from the distribution device 16 in the first position to the first conveyor track 20. For example, after a predetermined period of time or a predetermined number of articles 12, the distribution device 16 can switch over and move to the second position, in which the distribution device 16 directs a row of a plurality of articles 12 to the second conveyor track 22. After a predetermined period of time or a predetermined number of articles, for example, the distribution device 16 can switch over again and move to the first position, etc.

Even if the distribution device 16 can move very rapidly between the first position and the second position, upon the switching over of the distribution device 16 between the first position and the second position, at least one article 12 can be positioned undistributed partially on the first conveyor track 20 and partially on the second conveyor track 22 by the distribution device 16 that switches over or moves (see FIG. 3). This at least one undistributed article 12 can then be excited to move to the first conveyor track 20 or the second conveyor track 22 by means of the height-offset conveyor portion 31. It is possible that the excitement to move the at least one undistributed article 12 is supported by the angle of inclination α and/or by the angle of inclination β.

Preferably, the apparatus 10 can achieve a conveying capacity of ≥60,000 articles per hour or ≥80,000 articles per hour using this technology, for example up to 100,000, 150,000 or more articles per hour.

It is possible that the apparatus 10 has an optional air supply device 46. The air supply device 46 can, for example, be configured as a compressed air nozzle or a blower. The air supply device 46 can be arranged to supply an air flow to the articles 12, preferably the undistributed articles 12, for movement towards the first conveyor track 20 or the second conveyor track 22. The air supply device 46 can preferably be arranged in such a manner that it supplies the air flow to the articles 12 in the height-offset conveyor portion 31 or upstream thereof. By blowing on the at least one undistributed article 12 by means of the air supply device 46, the undistributed article 12 can also be excited to move to the first conveyor track 20 or the second conveyor track 22.

It is also possible that the air supply device 46 is activated only temporarily if a sensor system (not shown) detects an undistributed article. Preferably, the air supply device 46 can be temporarily activated by a control unit of the apparatus 10 precisely if the detected undistributed article 12 passes the air supply device 46.

FIG. 4 shows a container handling system 48 for handling containers.

The container handling system 48 has the apparatus 10 for conveying and apportioning the articles 12 configured as containers. Different container handling apparatuses or container handling machines 50, 52 and/or 54 for handling the containers can be arranged upstream and/or downstream of the apparatus 10.

The container handling apparatus 50 can be arranged upstream of the apparatus 10. The container handling apparatus 52 can be arranged downstream of the first conveyor track 20 of the apparatus 10. The container handling apparatus 54 can be arranged downstream of the second conveyor track 22 of the apparatus 10.

For example, the container handling apparatuses 52 and 54 can be configured as different portions of a pasteurizing apparatus (for example, a double-deck pasteurizing apparatus) for pasteurizing the containers. A first container inlet of the pasteurizing apparatus can be arranged downstream of the first conveyor track 20 of the apparatus 10. A second container inlet of the pasteurizing apparatus can be arranged downstream of the second conveyor track 22 of the apparatus 10.

In a further example, the container handling apparatus 50 can be configured as a filling apparatus, preferably a filler carousel, for filling the containers with a liquid or pasty medium.

Alternatively or additionally, the container handling apparatus 52 can be configured as a first inspection apparatus for inspecting the containers, and the container handling apparatus 54 can be configured as a second inspection apparatus for inspecting the containers.

In another example, the container handling apparatus 52 can be configured as a first packaging apparatus for packaging the containers, and the container handling apparatus 54 can be configured as a second packaging apparatus for packaging the containers.

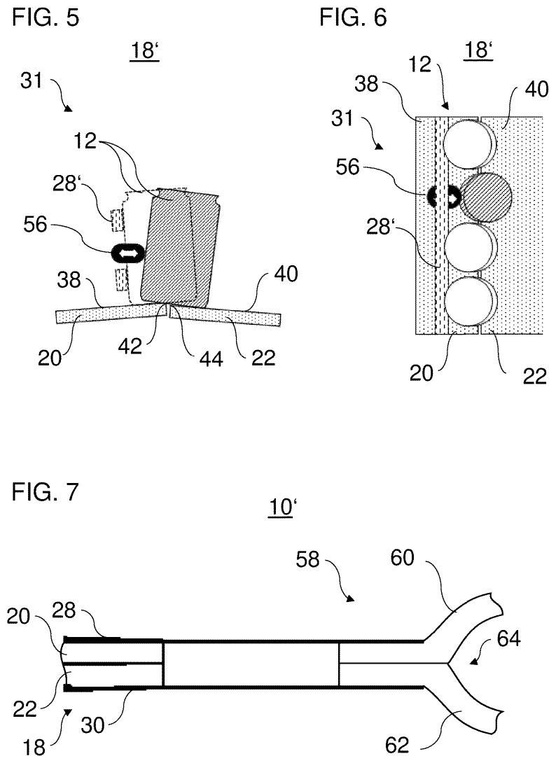

FIGS. 5 and 6 show a modified or supplemented embodiment compared to the embodiment described with reference to FIGS. 1 to 3.

The dual-track conveyor region 18′ can have an overfeed device 56. The overfeed device 56 can, for example, be configured as a retractable and extendable slide or as a flap that can be swung in and out. The overfeed device 56 can be mounted on the guide 28′, for example. Optionally, the guide 28′ can be transferred towards the second conveyor track 22 in the region of the assembly of the overfeed device 56, i.e. it cannot be arranged exactly on the outer longitudinal side of the first conveyor track 20. The overfeed device 56 can be actuated (for example, extended or pivoted out), in order to overfeed an undistributed article 12 to the second conveyor track 22 (or alternatively to the first conveyor track 20) by means of contact between the overfeed device 56 and the undistributed article 12.

It is possible that the overfeed device 56 is only temporarily activated or actuated (for example, extended or swung out) if a sensor system (not shown) detects an undistributed article. Preferably, the overfeed device 56 can be temporarily activated by a control unit of the apparatus 10 precisely if the detected undistributed article 12 passes the overfeed device 56. The overfeed device 56 can be arranged in the height-offset conveyor portion 31, for example in the ramp conveyor sub-portion 34, in the constant offset conveyor sub-portion 32 or in the slope conveyor sub-portion 36, or downstream thereof.

FIG. 7 shows a modified or supplemented embodiment compared to the embodiment described with reference to FIGS. 1 to 3.

The apparatus 10′ can have a further conveyor region 58 with a first conveyor track 60 and a second conveyor track 62.

The first conveyor track 60 can be arranged downstream of the first conveyor track 20 of the apparatus 10. The second conveyor track 62 can be arranged downstream of the second conveyor track 22 of the apparatus 10. The conveyor tracks 60 and 62 can diverge or move away from one another to form a gap or free space 64 between them. The gap 64 can preferably not be secured at its upstream end, so that at the upstream end, undistributed articles 12 are not prevented from being moved into the gap 64. As a result, articles 12 that are still undistributed downstream of the height-offset conveyor portion 31 can fall into the gap 64 and be caught there, for example. On the other hand, it is also possible that a table or another conveyor is arranged in the gap 64, for example, which receives the undistributed articles 12.

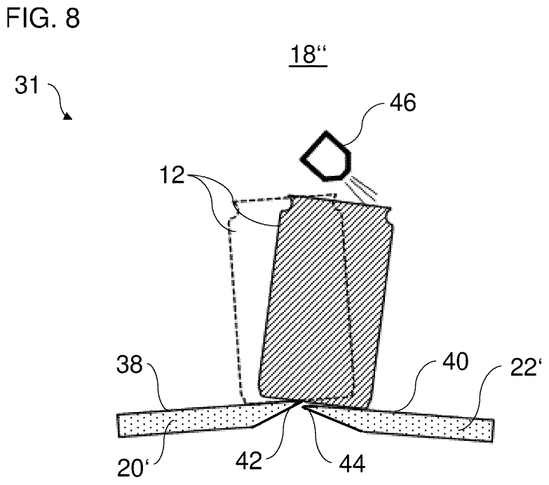

FIG. 8 shows a modified or supplemented embodiment compared to the embodiment described with reference to FIGS. 1 to 3.

The first conveyor track 20′ and the second conveyor track 22′ can be configured in such a way that they taper towards one another or converge to a point. In detail, conveyor mats or conveyor belts of the first conveyor track 20′ and the second conveyor track 22′ can taper towards one another or converge to a point. In other words, the longitudinal sides facing one another of the first and second conveyor tracks 20′, 22′ or their conveyor mats or conveyor belts can taper towards one another or converge to a point.

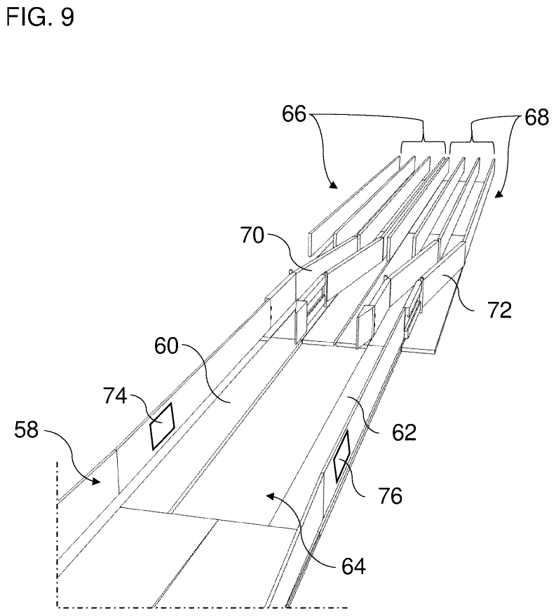

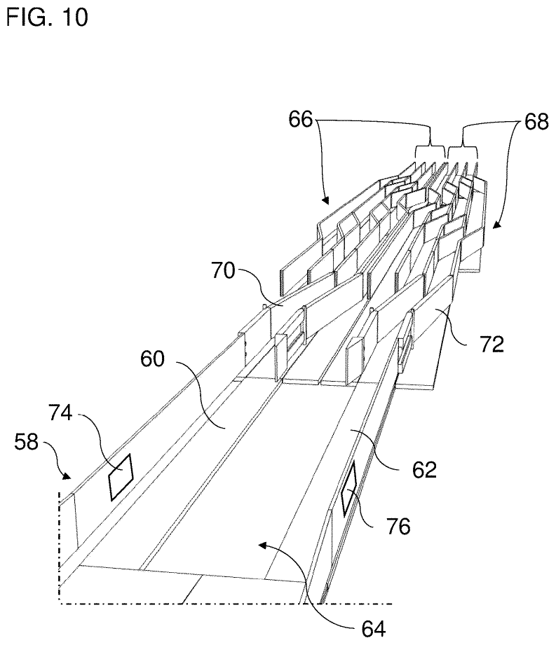

FIGS. 9 and 10 in each case show a portion of the apparatus 10 that can optionally be arranged downstream of the dual-track conveyor region 18.

In this portion, the apparatus 10 can further have a first multi-track conveyor region 66, a second multi-track conveyor region 68, a first apportioning device 70 and/or a second apportioning device 72.

The first multi-track conveyor region 66 can be arranged downstream of the first conveyor track 20 of the dual-track conveyor region 18 (see FIGS. 1 to 5). Preferably, the first multi-track conveyor region 66 is arranged downstream of the conveyor track 60 of the further conveyor region 58 (see FIGS. 7, 9 and 10).

The first multi-track conveyor region 66 can, for example, have three tracks, as shown in FIGS. 9 and 10. The first multi-track conveyor region 66 can also have more or less than three tracks. Preferably, the tracks of the first multi-track conveyor region 66 can run parallel. Preferably, the tracks of the first multi-track conveyor region 66 can be separated from one another by guides or walls. The tracks of the first multi-track conveyor region 66 can, for example, be configured as lanes. The tracks of the first multi-track conveyor region 66 can preferably be ≥1 m, ≥2 m, ≥3 m or ≥4 m long.

The second multi-track conveyor region 68 can be arranged downstream of the second conveyor track 22 of the dual-track conveyor region 18 (see FIGS. 1 to 5). Preferably, the second multi-track conveyor region 68 is arranged downstream of the conveyor track 62 of the further conveyor region 58 (see FIGS. 7, 9 and 10).

The second multi-track conveyor region 68 can, for example, have three tracks, as shown in FIGS. 9 and 10. The second multi-track conveyor region 68 can also have more or less than three tracks. Preferably, the tracks of the second multi-track conveyor region 68 can run parallel. Preferably, the tracks of the second multi-track conveyor region 68 can be separated from one another by guides or walls. The tracks of the second multi-track conveyor region 68 can, for example, be configured as lanes. The tracks of the second multi-track conveyor region 6 can preferably be ≥1 m, ≥2 m, ≥3 m or ≥4 m long.

Preferably, the first and second multi-track conveyor regions 66, 68 are operated in such a way that the articles conveyed from them are decelerated. This can be achieved, for example, by a reduced conveying speed compared to the two-lane conveyor region 18 (as in FIG. 9) or by overfeeds to successively slower-running conveyors of the respective first or second conveyor region 66, 68 (as in FIG. 10) or otherwise. Preferably, the successively or sequentially arranged conveyors can have a so-called knife edge overfeed. A so-called knife edge enables the smallest possible deflection radius at the end of the belt. The smaller the deflection radius can be as a result, the more gently articles that are at risk of tipping and unstable articles can be transported from one belt to a subsequent belt, possibly with an additional change in conveyor speed.

Downstream of the first and second multi-track conveyor regions 66, 68, for example, one or more container handling apparatuses can be arranged, for example those exemplified herein with reference to FIG. 4.

The first apportioning device 70 apportions the articles 12 originating from the first conveyor track 20 to the first multi-track conveyor region 66. The first apportioning device 70 can preferably be moved between a plurality of positions. In a first position, the first apportioning device 70 can distribute articles 12 originating from the first conveyor track 20 to a first track of the first multi-track conveyor region 66. In a second position, the first apportioning device 70 can distribute articles 12 originating from the first conveyor track 20 to a second track of the first multi-track conveyor region 66, etc. The first apportioning device 70 can, for example, be configured as a pivot channel or a pivot flap.

The second apportioning device 72 apportions the articles 12 originating from the second conveyor track 22 to the second multi-track conveyor region 68. The second apportioning device 72 can preferably be moved between a plurality of positions. In a first position, the second apportioning device 72 can distribute articles 12 originating from the second conveyor track 22 to a first track of the second multi-track conveyor region 68. In a second position, the second apportioning device 72 can distribute articles 12 originating from the second conveyor track 22 to a second track of the second multi-track conveyor region 68, etc. The second apportioning device 72 can, for example, be configured as a pivot channel or a pivot flap.

Particularly preferably, the apportioning devices 70, 72 are switched in such a way that they are only switched over between their respective positions if there is a gap L (see FIG. 2) between successive rows of articles 12 in a respective received stream of articles. These gaps L can be caused in particular by switching the distribution device 16 and optionally by exciting the articles 12 still undistributed to move to the first conveyor track 20 or the second conveyor track 22.

The gaps L can be detected, for example, by a sensor system 74, 76. The control unit of the apparatus 10 can control the apportioning devices 70, 72 as a function of the gaps L detected by the sensors 74, 76 for switching over in the respective gaps L. It is also possible that the position and/or extent of the gaps L are estimated by the control unit on the basis of an operation or control of the distribution device 16.

The sensor system 74, 76 can be an optical sensor system, for example. The sensor system 74, 76 can preferably be camera-supported and/or have at least one light barrier.

The portions monitored by the sensor system 74, 76 can, for example, be arranged at least 300 mm, at least 400 mm, at least 500 mm or at least 600 mm upstream of the first and second apportioning devices 70, 72.

Preferably, a first sensor 74 can monitor a portion upstream of the first apportioning devices 70 for gaps L between successive rows of articles 12. For example, a second sensor 76 can monitor a portion upstream of the second apportioning device 72 for gaps L between successive rows of articles 12.

The sensor system 74, 76 can preferably be arranged on the further conveyor region 58. For example, the first sensor 74 can be arranged at or near the conveyor track 60 of the further conveyor region 58. The second sensor 76 can, for example, be arranged at or near the conveyor track 62 of the further conveyor region 58.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1 and, for example, independently of the features with respect to the presence and/or configuration of the single-track conveyor region, the dual-track conveyor region, the first conveyor track, the second conveyor track, the distribution device and/or the height-offset conveyor portion of independent claim 1. All ranges specified herein are to be understood as disclosed in such a way that all values falling within the respective range are individually disclosed, e.g., also as the respective preferred narrower outer limits of the respective range.

List of Reference Signs

| | |
|---|---|
| 10 | Apparatus for conveying and apportioning articles |
| 12 | Article |
| 14 | Single-track conveyor region |
| 16 | Distribution device |
| 18 | Dual-track conveyor region |
| 20 | First conveyor track |
| 22 | Second conveyor track |
| 24 | Guide |
| 26 | Detection device |
| 28 | Guide |
| 30 | Guide |
| 31 | Height-offset conveyor portion |
| 32 | Constant offset conveyor sub-portion |
| 34 | Ramp conveyor sub-portion |
| 36 | Slope conveyor sub-portion |
| 38 | Upper-side conveyor face |
| 40 | Upper-side conveyor face |
| 42 | Upper longitudinal edge |
| 44 | Upper longitudinal edge |
| 46 | Air supply device |
| 48 | Container handling system |
| 50 | Container handling device |
| 52 | Container handling device |
| 54 | Container handling device |
| 56 | Overfeed device |
| 58 | Further conveyor region |
| 60 | First conveyor track |
| 62 | Second conveyor track |
| 64 | Gap or free space |
| 66 | First multi-track conveyor region |
| 68 | Second multi-track conveyor region |
| 70 | First apportioning device |
| 72 | Second apportioning device |
| 74 | First sensor |
| 76 | Second sensor |
| α | Angle of inclination |
| β | Angle of inclination |

1. An apparatus for conveying and apportioning articles, preferably containers, having:
a single-track conveyor region;
a dual-track conveyor region, which is arranged directly downstream of the single-track conveyor region and has a first conveyor track and a second conveyor track; and
a distribution device, which is configured to apportion articles conveyed from the single-track conveyor region to the first conveyor track and the second conveyor track,
wherein:
the dual-track conveyor region has a height-offset conveyor portion in which the first conveyor track is higher than the second conveyor track.

2. The apparatus according to claim 1, wherein at least one of:
in the height-offset conveyor portion, an upper-side conveyor face of the first conveyor track is arranged higher than an upper-side conveyor face of the second conveyor track; and/or
the first conveyor track and the second conveyor track have upper longitudinal edges opposing one another and, in the height-offset conveyor portion, the upper longitudinal edge of the first conveyor track is arranged higher than the upper longitudinal edge of the second conveyor track.

3. The apparatus according to claim 1, wherein at least one of:
the first conveyor track is inclined away from the second conveyor track; and
the second conveyor track is inclined away from the first conveyor track.

4. The apparatus according to claim 1, wherein:
the first conveyor track and the second conveyor track are inclined in opposite directions relative to one another.

5. The apparatus according to claim 3, wherein one of:
an angle of inclination (α) of the first conveyor track and an angle of inclination (β) of the second conveyor track are of different sizes; and
an angle of inclination (α) of the first conveyor track is greater than an angle of inclination (β) of the second conveyor track.

6. The apparatus according to claim 1, wherein at least one of:
the height-offset conveyor portion has a ramp conveyor sub-portion, and in the ramp conveyor sub-portion the first conveyor track rises relative to the second conveyor track; and/or
the dual-track conveyor region has a slope conveyor sub-portion, and in the slope conveyor sub-portion the first conveyor track drops.

7. The apparatus according to claim 1, wherein:
longitudinal sides facing one another of the first conveyor track, and of the second conveyor track, taper towards one another or converge to a point relative to one another.

8. The apparatus according to claim 1, wherein at least one of the following features is fulfilled:
the distribution device is movable between a first position, in which the distribution device is positioned for distributing the articles to the first conveyor track, and a second position, in which the distribution device is positioned for distributing the articles to the second conveyor track;
the distribution device is configured as a pivot flap or a pivot channel;
the distribution device is arranged at a downstream end of the single-track conveyor region; and
the apparatus further has detection device, which is arranged to detect gaps between the articles conveyed by the single-track conveyor region, and a control unit, which is configured to control the distribution device as a function of a signal from the detection device.

9. The apparatus according to claim 1, further having:
an air supply device for supplying the articles with an air flow for movement towards the first conveyor track or the second conveyor track,
wherein the air supply device for supplying the articles with the air flow is arranged in the height-offset conveyor portion or upstream of the height-offset conveyor portion.

10. The apparatus according to claim 1, further having:
an overfeed device, which is actuatable to contact an article to overfeed the article to the first conveyor track or the second conveyor track and is arranged downstream of the distribution device.

11. The apparatus according to claim 1, further having:
a further conveyor region which has two diverging conveyor tracks, one of which is arranged downstream of the first conveyor track and the other of which is arranged downstream of the second conveyor track,
wherein the two diverging conveyor tracks diverge to form a gap between them,
wherein an upstream end of the gap is unsecured.

12. The apparatus according to claim 1, wherein:
the apparatus has a conveying capacity of ≥60,000 articles per hour.

13. The apparatus according to claim 1, further having:
a first multi-track conveyor region, which is arranged downstream of the first conveyor track;
a second multi-track conveyor region, which is arranged downstream of the second conveyor track;
a first apportioning device, which is configured to apportion articles conveyed downstream of the first conveyor track to the first multi-track conveyor region; and
a second apportioning device, which is configured to apportion articles conveyed downstream of the second conveyor track to the second multi-track conveyor region.

14. The apparatus according to claim 13, wherein at least one of:
the first apportioning device is controlled to switch in gaps between successive rows of articles conveyed downstream of the first conveyor track for switching between tracks of the first multi-track conveyor region; and
the second apportioning device is controlled to switch in gaps between successive rows of articles conveyed downstream of the second conveyor track for switching between tracks of the second multi-track conveyor region.

15. The apparatus according to claim 13, wherein at least one of:
the first multi-track conveyor region and the second multi-track conveyor region is controlled to decelerate the respective conveyed articles.

16. A container handling system for handling containers, having:
an apparatus according to claim 1,
wherein the container handling system further has one of:
a pasteurizing apparatus for pasteurizing the containers, wherein the pasteurizing apparatus has a first container inlet, which is arranged downstream of the first conveyor track, and a second container inlet, which is arranged downstream of the second conveyor track; and
a first inspection apparatus for inspecting the containers, which is arranged downstream of the first conveyor track, and a second inspection apparatus for inspecting the containers, which is arranged downstream of the second conveyor track; and
a first packaging apparatus for packaging the containers, which is arranged downstream of the first conveyor track, and a second packaging apparatus for packaging the containers, which is arranged downstream of the second conveyor track; and
a first container handling machine for handling the containers, which is arranged downstream of the first conveyor track, and a second container handling machine for handling the containers, which is arranged downstream of the second conveyor track.

17. A method for conveying and apportioning articles via an apparatus according to claim 1, wherein the method comprises:
apportioning of a stream of articles from a single-track conveyor region to a first conveyor track and a second conveyor track of a dual-track conveyor region via a distribution device, wherein, upon a switching over of the distribution device, at least one article of the stream of articles is positioned undistributed partially on the first conveyor track and partially on the second conveyor track;
exciting the at least one undistributed article to move to one of the first conveyor track and the second conveyor track via a height-offset conveyor portion of the dual-track conveyor region, in which the first conveyor track is arranged higher than the second conveyor track.

18. The method according claim 17, wherein the method further comprises at least one of:
blowing the at least one undistributed article via an air supply device for moving it to one of the first conveyor track and the second conveyor track;
overfeeding the at least one undistributed article to the first conveyor track or the second conveyor track via actuating an overfeed device;
supporting the excitation by an inclination of at least one of the first conveyor track and the second conveyor track.

19. The method according to claim 17, further comprising:
apportioning a first partial stream of articles downstream of the first conveyor track into tracks of a first multi-track conveyor region via a first apportioning device; and
apportioning a second partial stream of articles downstream of the second conveyor track into tracks of a second multi-track conveyor region via a second apportioning device.

20. The method according claim 19, wherein the method further comprises at least one of:
that, upon apportioning the first partial stream of articles, the first distribution device switches in gaps between tracks of the first multi-track conveyor region between successive rows of the first partial stream of articles caused by the apportioning of the stream of articles by the distribution device;
that, upon apportioning the second partial stream of articles, the second distribution device switches in gaps between tracks of the second multi-track conveyor region between successive rows of the second partial stream of articles caused by the apportioning of the stream of articles by the distribution device;
decelerating articles from the first partial stream of articles via the first multi-track conveyor region; and
decelerating articles from the second partial stream of articles via the second multi-track conveyor region.
